(19) United States
(12) Patent Application Publication
(10) Pub. No.: US 2019/0319813 A1
(43) Pub. Date: Oct. 17, 2019

(54) SYSTEMS AND METHODS FOR FOSTERING ON-LINE WORKING RELATIONSHIPS AND VIRTUAL TEAM BUILDING

(71) Applicant: Jumana ABU-GHAZALEH, New York, NY (US)

(72) Inventor: Jumana ABU-GHAZALEH, New York, NY (US)

(21) Appl. No.: 16/463,635

(22) PCT Filed: Nov. 23, 2017
(86) PCT No.: PCT/CA2017/051402

§ 371 Date: May 23, 2019

Related U.S. Application Data
(60) Provisional application No. 62/427,485, filed on Nov. 29, 2016.

(51) Int. Cl. H04L 12/18; H04L 12/58; G06Q 10/10

(52) U.S. Cl. CPC H04L 12/1822; G06Q 10/103; H04L 51/046

(57) ABSTRACT

A system and computer implemented method for fostering person-to-person engagement in a virtual team having a plurality of team members is provided. The systems and methods facilitate guided reciprocal self-disclosure that is both gradual and orderly by sharing of answers to questions that optionally progress from superficial to intimate.

### FIELD OF THE INVENTION

This invention pertains to virtual teams and in particular, to systems and methods for fostering on-line or virtual working relationships and virtual team building.

### BACKGROUND OF THE INVENTION

Strong relationships, those based on trust, are the lifeblood of a healthy professional ecosystem but they are extremely challenging to create and build, particularly in the social networking age: limited resources (time, money, attention), limited access and geography (time zones, language, culture) make it difficult to build and develop the camaraderie requisite for innovation and productivity.

Human beings have long relied on face-to-face dialogue and small talk to get to know each other and build interpersonal understanding and collegiality. In a world where work is increasingly digital and increasingly remote, it is challenging for professionals to develop the kind of rapport and trust necessary for productive business relationships and teamwork. Accordingly, there exists a need for tools to facilitate the development of rapport and trust necessary for productive business relationships and teamwork.

Effective and persuasive communications appeal to all three of the sides of the so-called Rhetorical Triangle—namely, logos (logic, facts, or truth); pathos (emotional appeal) and ethos (speaker or writers character, credibility, and authority). An argument that is purely based on emotion won't last for very long. Likewise, a presentation of facts and figures will lose your audience's interest and they won't be able to relate to what you are saying. Finally, if you don't make sense, or your arguments aren't logically, you won't be considered credible.

According to the social penetration theory, as relationships deepen, interpersonal communication moves from the superficial (i.e. shallow, non-intimate level) to more meaningful intimate communication.

The social penetration theory states that this process occurs primarily through self-disclosure and closeness develops if the participants proceed in a reciprocal, gradual and orderly fashion from superficial to intimate levels of exchange of information.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide systems and methods for fostering on-line working relationships and virtual team building.

In accordance with an aspect of the present invention, there is provided a computer implemented method for fostering person-to-person engagement in a virtual team having a plurality of team members, the method comprising of inviting members to a virtual team and providing a virtual team building environment; providing each team member of the virtual team one or more questions; tagging team members based on which of the one or more questions is answered and/or how they were answered; providing access to all answers to a specific question to those team members who have answered the specific question and optionally providing an open discussion forum to the team members who have answered the specific question.

In accordance with another aspect of the present invention, there is provided a computer implemented method for fostering person-to-person engagement in a virtual team having a plurality of team members, the method comprising of inviting members to a virtual team and providing a virtual team building environment; providing each team member of the virtual team a first set of questions; tagging team members based on if one or more questions is answered and/or how they are answered; and providing access to a second set of questions to those team members which answered at least one question in the first set of questions; wherein each set of questions comprise one or more questions and optionally providing an open discussion forum to the team members who have answered at least one question in the first set of questions.

In accordance with another aspect of the invention, there is provided a system configured to implement a method for fostering person-to-person engagement in a virtual team having a plurality of team members, the system comprising one or more servers configured to host a virtual team building environment; the one or more servers comprising one or more physical processors configured to execute computer program modules, the computer program modules comprising a network and user management module configured to provide a user interface; a user database comprising a plurality of user records; a question database comprising a plurality of questions, each question has one or more tags; a question engine configured to provide questions to active users in the user database on set schedule, and a conversation engine operative with the question engine and user database, wherein the question engine selects questions from the question database based on the one or more tags and wherein conversation engine is configured to restrict viewing of answers to questions posed only to teams members who have also answered the question.

### BRIEF DESCRIPTION OF THE DRAWINGS

These and other features of the invention will become more apparent in the following detailed description in which reference is made to the appended drawings.

FIG. 1A illustrates a network created by the method of the invention over time. The connections between team members do not remain static. Relationship strength is represented by line thickness. The arrows on both ends of the connecting lines are representative of the reciprocal nature of the relationships.

FIG. 1B is an illustration detailing the network typical to traditional social media where each node radiates lines of identical width.

FIG. 2A is a flowchart detailing a method of reciprocal sharing and progressive disclosure in one embodiment of the invention.

FIG. 2B is a flowchart detailing the method of reciprocal sharing and progressive disclosure in one embodiment of the invention where clustered questions are used.

FIG. 3 is a diagram representing components of the system.

### DETAILED DESCRIPTION OF THE INVENTION

The invention provides a virtual conversation engine and environment designed to foster person-to-person engagement and dialogue to facilitate the development of deeper, more meaningful professional relationships. The systems and methods of the invention promote a feeling in virtual teams of psychological safety and foster the shared belief that the virtual team is safe for interpersonal risk taking. In psychologically safe teams, team members feel accepted and respected.

A technology platform to facilitate the building of trust between team members and to bridge emotional distance that may be exacerbated in professional relationships predominantly or exclusive occurring in a virtual environment is provided. As are, systems and methods for guided reciprocal self-disclosure.

The guided reciprocal self-disclosure is both gradual and orderly and is facilitated by sharing of answers to questions that, optionally, progress from superficial to intimate in levels or layers. The sharing of answers only occurs between team members that have answered one or more of the same questions. In some embodiments, access to particular answers is only available if the viewing team member has also answered that question.

The system is optionally configured to monitor user engagement and where needed (i.e. to foster a better experience and deeper engagement), has the ability to send a message or follow up question to an individual, a number of members, a group, all groups, or all networks. Optionally, this message may appear as either a Direct Message or as a message in a Discussion Channel. This process can either be manually orchestrated through a “man-in-the-middle” approach or through an automated process that relies of measurements, machine learning, and optionally artificial intelligence.

The system and method may be configured to support one or more independent groups. In embodiments with multiple groups, the system is optionally configured to allow each group to engage the system independently where each group has its own timeline and dedicated channels for their respective discussions.

Optionally in multiple group systems, the system may be configured to shuffle members and groups. In such embodiments, the administrator can either manually trigger a “shuffling” of members into new groups or rely on the system to suggest when might be a suitable time to shuffle the groups. Once activated, the system can either randomly assign users into new groups or analyze past data gathered from members to recommend group compositions more likely to lead to positive interactions. In some embodiments, a trigger to shuffle groups includes hiring of a specified number of new employees. In some embodiments, a trigger to shuffle groups may be based on how long groups have been established and/or the interpersonal relationships between group members appear to be well established.

In some embodiments, the system is configured to deliver modified scope of experiences for certain networks to better cater to their requirements. For example, the scenario of a conference organizer encouraging attendees to learn more about each other before the conference might be different than a team collaborating over a longer time period. The system allows catering the experience and the contents (questions, material) to better deliver this optimized scope.

In some embodiments, the system and methods are modified based on industry or profession of the team and optionally, the level of trust generally displayed in that industry.

The system and methods may be configured for the size of the organization. In some embodiments for medium to large organization, the system is configured to automate the group setup, including sending bulk invites rather than manually inviting users to each group. In such embodiments, the system is configured to send out bulk invitations based on lists generated from human resource files or platforms used by groups to facilitate communication or user groups.

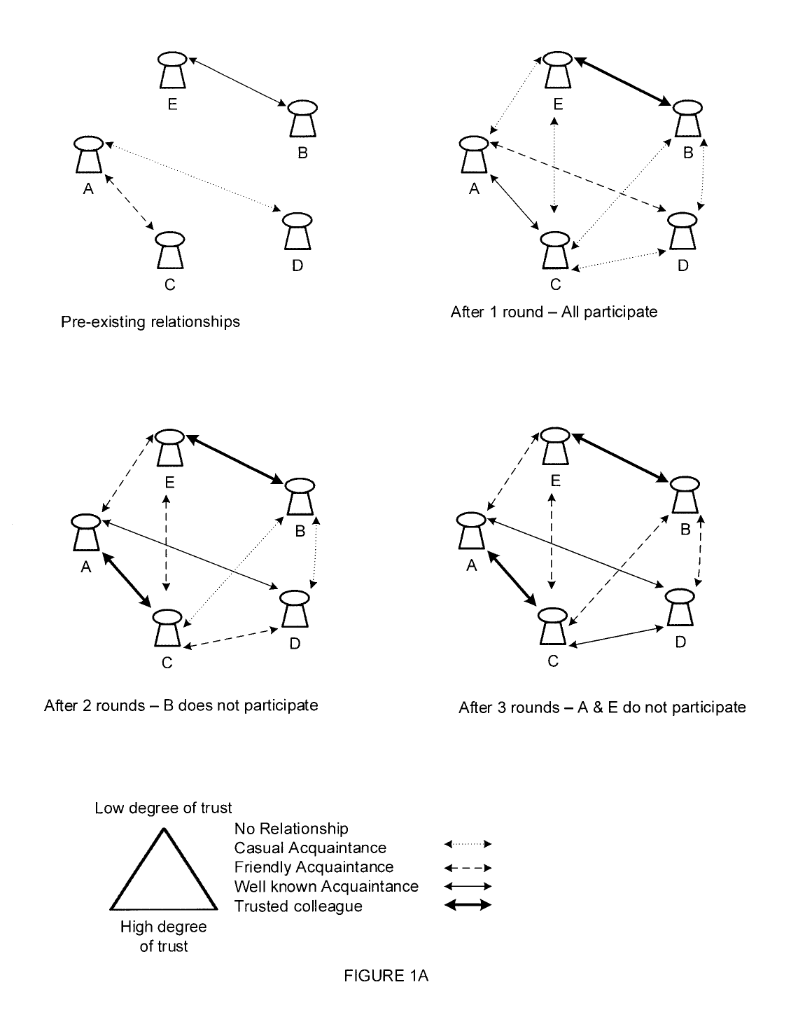

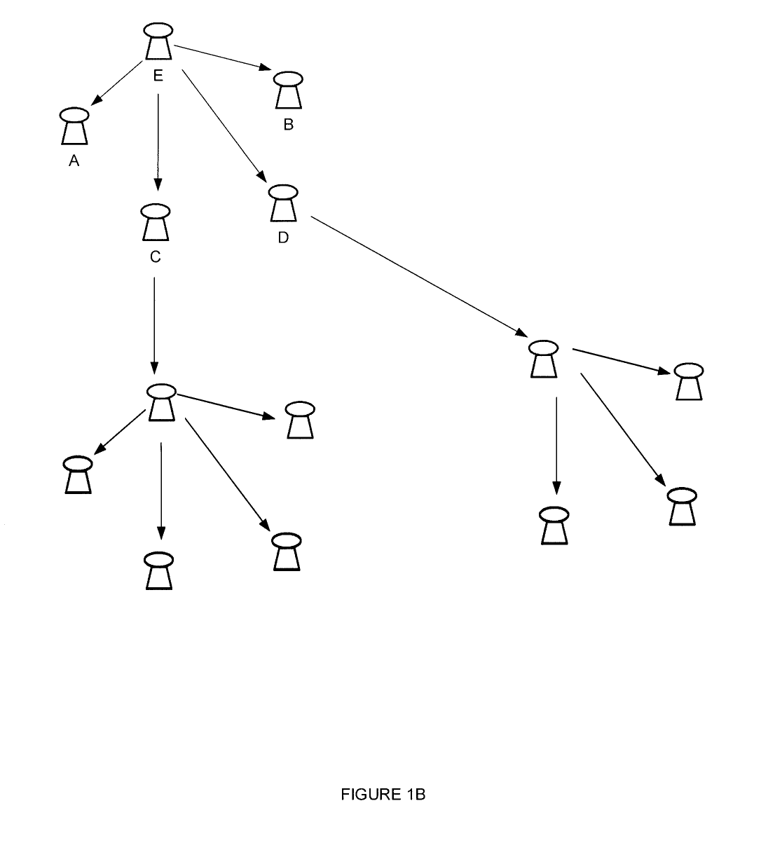

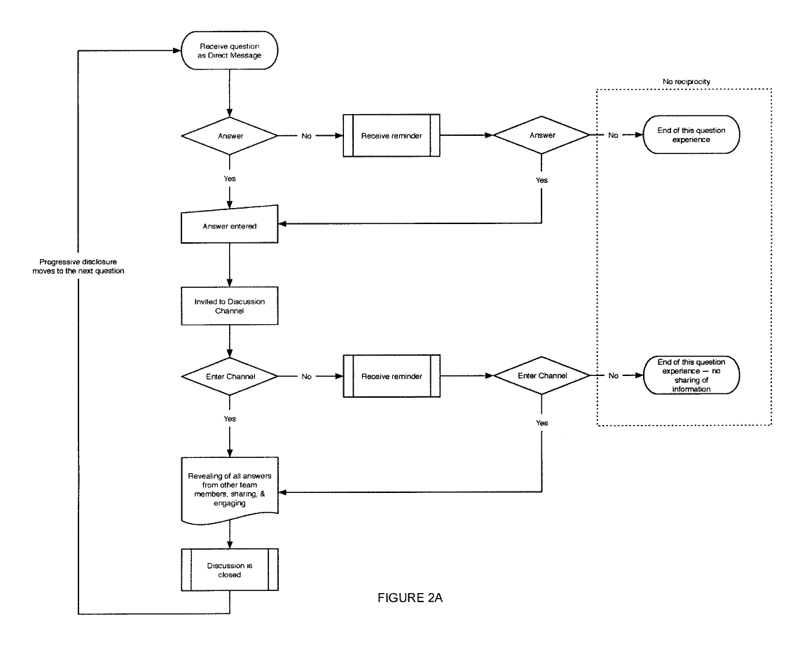

FIG. 1 illustrates the potential to build of stronger relationships over time using the methods and systems of the invention. Prior to engaging the system and method, members of a team may have pre-existing relationships of varying degrees of closeness. Over multiple rounds of questions, team members who choose to participate in the reciprocal sharing may develop stronger, more trusting relationships. This is in contrast to traditional social media where information flows one way (as represented by the arrow heads in FIG. 1B). In these traditional social media, in order to develop stronger, more trusting relationships, team members would have to engage each other outside the confines of the method and system. Depending on the individuals such interactions may be stilted or awkward as the interaction are not generally guided or facilitated.

In some embodiments, the method and system can assess profiles of team members or potential team members for a high level of similarity or complementarity. In such embodiments, the method and system can orchestrate an introduction in a two-step process: 1) a “glimpse” experience of answering/sharing up to 9 questions before deciding if both users want to learn more about each other. This progression to the full engagement is referred to as a collision.

In some embodiments, the method and system can use on-boarding [OB] with group members and team captains or leaders to set a baseline for team cohesion and/or health, optionally the on-boarding is via a mini-survey. The mini-survey queries team members regarding their perceptions regarding the team and its members including level of trust and compatibility of team members. Results of the on-boarding are not shared with team members. On-boarding may be conducted periodically to check team cohesion and/or health. In some embodiments, on-boarding can be used to check for impact of events, including promotions of team members, organizational changes, company downsizing, and new hiring have on team cohesion and/or health.

In some embodiments, the method and system can use a “Lightning Round” [LR] as a simple and fun way for group members to begin to get comfortable with engaging with the system. The Lightning Rounds includes a few rapid-fire, survey-style questions answers to which will be shared to provide group members (teammates) mini-profiles on each other.

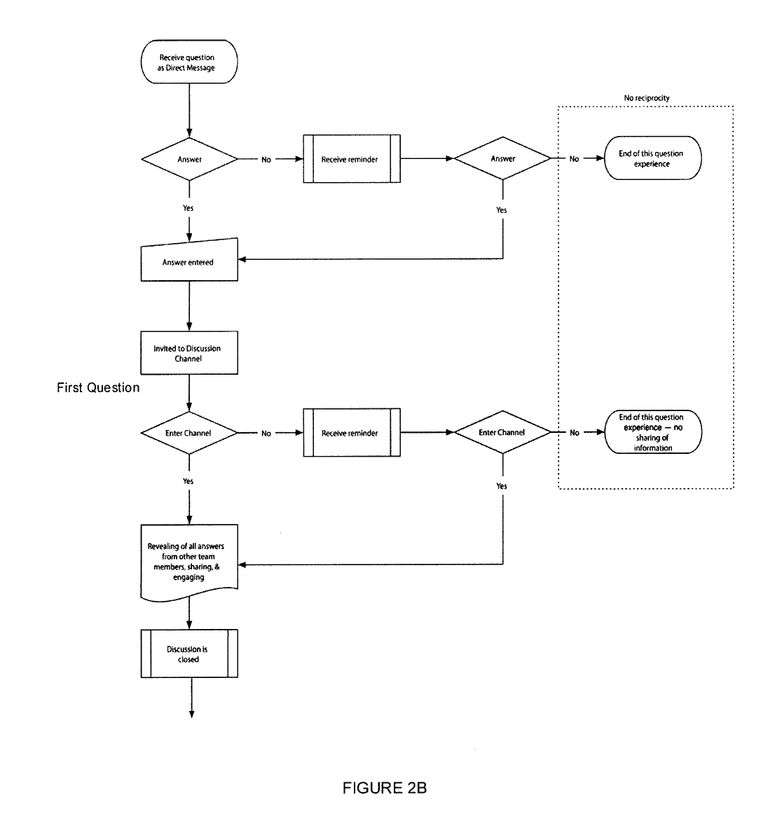

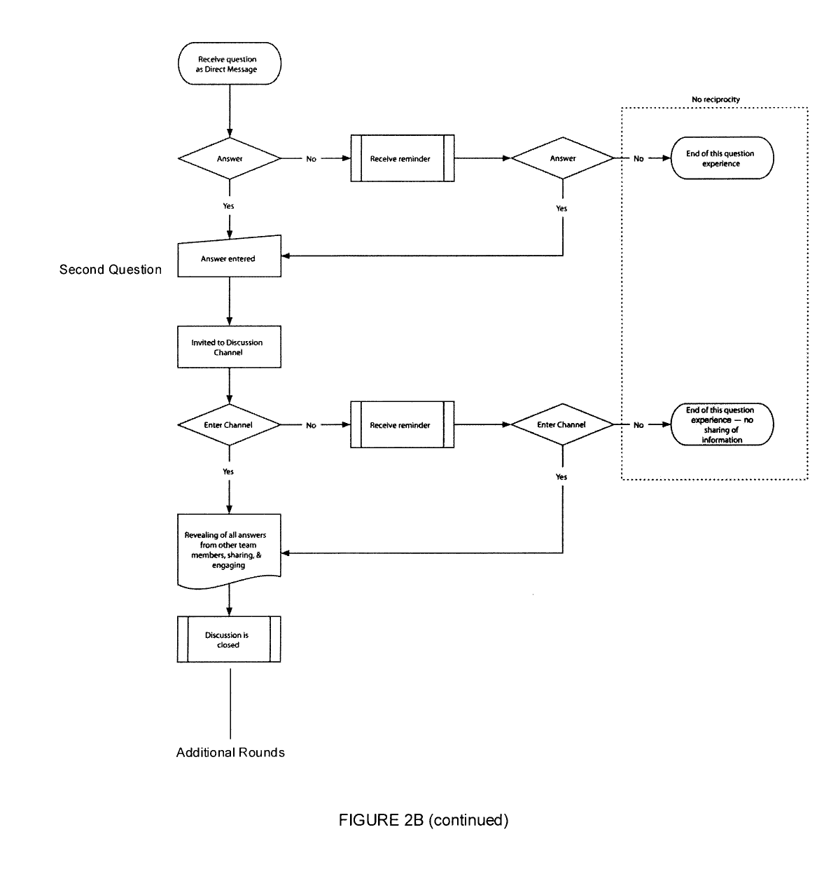

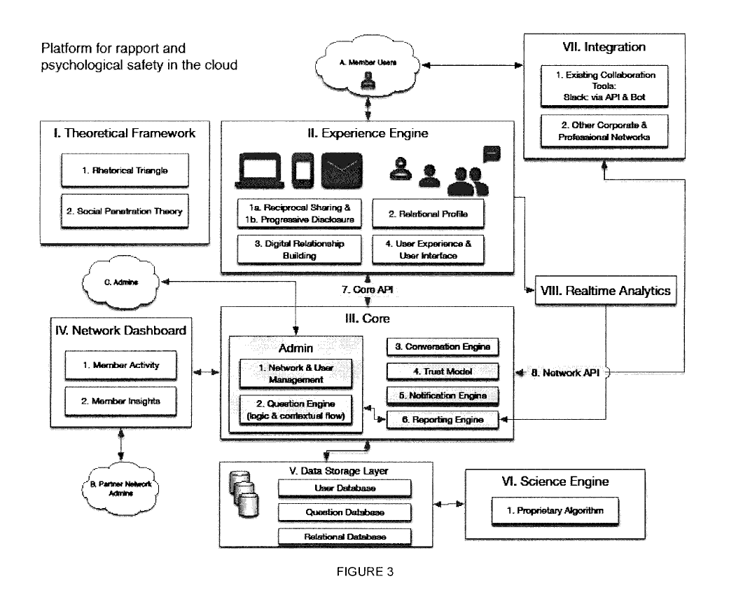

Referring to FIG. 2A, in some embodiments, a team member receives a tagged question as a direct message. Once the team member answers the question, an invitation to a discussion channel for that specific question is sent to that team member and other team members that have answered the question. The invited team members enter the discussion channel and the answers to the question from other team members are shown thereby encouraging free discussion of the question between team members who answered the question and optionally entered the discussion channel. As a result, team members who engage the process have an opportunity to development closer relationships. After a set period of time, the discussion channel is closed.

Optionally, a team member who answers the question but does not enter the discussion channel will receive a reminder to enter the channel. If the team member does not enter the channel, after a set period of time, the channel closes.

The discussion channel may optionally include discussion starters to facilitate the open discussion. For example, if the question is “Do you prefer action movies or dramas?” the discussion starters could include “What is your favorite action movie?”, “What do you look for in an action movie?”, “Do you re-watch movies you have seen?” etc.

Optionally, the discussion channel is a chat room that, in some embodiments, may be enabled for the use of webcams. In other embodiments, the discussion channels use instant message or other forms of real time communication.

In embodiments where the discussion channel is based on real time communication, team members who have answered the requisite question receive a notice of when at least one other team member has entered the discussion channel.

In some embodiments, team members who do not answer the question will receive at least one reminder.

In the illustrated embodiment, once the discussion channel is closed a new question is sent to all team members.

In some embodiments, the system is configured to allow for new team members and/or re-engage team members that have been absent for an extended period.

Referring to FIG. 2B, in some embodiments, questions are clustered such that access to other questions is limited to only those team members that have answered the first question or opening question in the cluster. In such embodiments, once the discussion channel is closed a new question is sent only to those team members that answered the previous question.

In other embodiments, access to clustered questions is open to any team member.

In some embodiments, the questions are multiple-choice questions, yes/no questions, or open-ended questions.

In some embodiments, the questions are media based questions including open ended or multiple-choice format.

In some embodiments, the questions and/or answers include or are images and/or media.

In some embodiments, the questions are ranking questions. In some embodiments, the questions are rating questions. In some embodiments, the questions incorporate a short game or riddle.

Optionally, the questions are sourced from Myers Briggs, Big 5 or OCEAN, entrepreneurial trait assessment, gamer profiles, recruiting resources, and career development and relationship-building models. The questions are optionally tagged to indicate the source of the question.

In some embodiments, the questions are custom or customized to meet a specific team's requirements or in view of a team building goal.

In some embodiments, the questions are network specific and/or network-tailored questions. Optionally, the system is configured to deliver a unique experience to each client network and/or tailor various parts of the experience. These include but are not limited to mode, timing and frequency of questions, language and tone of messaging from the system, and content (questions/material).

For existing teams, the questions may be customized based on current team dynamics and/or team history.

In some embodiments, the questions are customized to assess team interactions and dynamics. Optionally, the questions are customized to assess team member understanding of team vision or purpose and/or individual roles within the team.

The questions are characterized and tagged in accordance with a four-point scale that aligns with the Social Penetration Theory (1 of 4 is Surface, 2 of 4 is Personal, 3 of 4 is Intimate, and 4 of 4 is Core). The outside or superficial levels or layers include a mix of lower weighted questions (1 of 4 and 2 of 4), the deeper levels or layers move to a mix of progressively higher levels as the team begins to build trust with each other and the platform. For example, superficial questions could include food preferences, such as “Do you prefer chocolate, candy or chips?” or other preferences such as preferred sports, etc. Exemplary personal questions, could include questions such as “Who was your favorite teacher and why?” Exemplary intimate questions could include “When was the last time you cried happy tears?” Exemplary core questions include “Tell a story when you learned courage.”

In some embodiments, the questions are also tagged by day/time, for example, some questions may be tagged as being more appropriate for Monday morning, etc.

In some embodiments, the questions are tagged based on relative complexity and/or anticipated time to answer the question. For example, questions could be simple, moderate or complex.

Simple questions may require a single word answer. For example, “Do you like sleeping in?” Yes or No.

Moderate questions require more thought and may necessitate longer answers. An exemplary moderate question is “What two places have you called home?”

Complex questions may require more reflection and thought and may necessitate longer answers. For example, “What relationship has made all the difference in your life?”

In such embodiments, the question may include an indication of time required to answer the question.

In some embodiments, the questions are tagged by category. Categories can include but are not limited to specific topics such as work, play, sports, about others, about me, values & beliefs, and random.

In some embodiments, the questions are tagged by based on the F.O.R.D. technique and relate to family, occupation, recreation and dreams.

In some embodiments, tags are application, client, team, or platform specific.

In some embodiments, the question engine is configured to pull questions from the question pool (database) based on one or more tags. Optionally, the questions are pulled based on two or more tags.

In some embodiments, the question engine is configured to prioritize and/or order tags. For example, in some embodiments tags related to Social Penetration Theory are given a higher weighting than tags related to category.

In addition, the questions are tagged to correspond to one or more of the rhetorical appeals and are designed to encourage team members to share information by answering questions that reveal emotion, credibility and/or logic (i.e. ethos, pathos and/or logos).

In some embodiments, the system and/or methods are configured to provide team members with the option of providing feedback or encouragement to other team members. Optionally, in some embodiments, feedback or encouragement includes encouragement to team members to engage the method and system by answering the questions.

In some embodiments, the method and system are configured to track the type or format of questions answered based on one or more tags. In some embodiments, the method and system are configured to provide types of questions which have historically been answered by most team members and optionally limit or exclude the types of questions which have historically not been answered by most team members.

In some embodiments, the method and system are configured to allow for deferment of specific questions.

In some embodiments, the method and system are configured to provide team member feedback regarding specific questions and optionally provides for the removal of questions that a majority of team members either do not answer or mark as do not intend to answer.

Optionally, the system and method are configured to substitute a new question if a pre-determined percentage of team members do not answer a specific question within a pre-determined period of time.

In some embodiments, the method and system incorporate virtual team building games and/or puzzles to facilitate building relationships. In some embodiments, the team-building games and/or puzzles are designed to facilitate cooperation between team members.

The system and method of the invention are configured for reciprocal sharing and thereby limit or avoid “lurking” or “voyeurism” on the platform. By limiting the sharing of answers to questions to only those team members that also answered the question, the method and system encourages engagement and participation.

For example, user “A” can view the answers of another user “B” only if i) they belong to the same group or team and ii) user “A” also answers the question.

In some embodiments, a user can belong to more than one team. In such embodiments, answers or information in relation to one team is optionally imported or shared with one or more other team environments or platforms. This feature may optionally be turned off by the user.

In some embodiments, the system is configured to tabulate historical changes for a given question as it pertains to the similarity matching. As is the context: if a user decided to answer one way in one team and differently in another, that might have a contextual significance, so both combinations are stored and utilized.

In some embodiments, the system is configured to provide, based on historical changes, an assessment of team dynamics and/or cohesiveness and optionally changes therein over time.

The system and method of the invention are configured to facilitate progressive disclosure of information by team members. The systems and methods are configured such that users share information over time, rather than via large information dumps. In some embodiments, the systems and methods are configured to provide questions at established time-intervals—one question at a time at regular intervals mimics conversation patterns and norms versus the survey approach to information gathering used by social networks. Alternatively, the systems and methods are configured to provide a new question following submission of a response to a previous question.

The systems and methods of the invention are configured to provide in effect a profile of an individual taking into account context wherein an individual is not simply viewing information about the other, but viewing information about the other in relation to themselves such that no two people should experience a third person the same way. The system and methods provide profiles that are not static lists but dynamic representations of a relationship that take into account the viewer as well as the person being viewed. The systems and methods of the invention are configured to profiles the relationship between two individuals rather than presenting two individuals with profiles of each other.

The systems and methods of the invention facilitate the building of digital relationships by promoting one to one interaction as opposed to traditional social networks that facilitate the broadcasting of information to multiple connections and/or followers at the same time—the emphasis is on one-to-many communication rather than one-to-one engagement. Users can react, comment or share the content that a user posts, but is not typically incented to engage in dialogue with the poster.

The system of the invention includes a user interface. In some embodiments, the user interface is configured to provide a contextual approach to user experience that is designed to deliver relevancy and personal discovery and team member insight throughout the experience.

The system may be configured for use on desktops, laptops, tablets, and mobile devices. The method can be configured for mobile web displays, mobile applications, emails, mobile and in-browser notifications, or integration with existing network portals.

The system comprises a core that interfaces with user's hardware via software. The core is configured to provide all back-end functionality related to managing the all information related to questions, networks, and members and also contains the APIs related to communicating with network portals and client channels. The core provides network and user management module, question engine, conversation engine, notification engine, reporting engine, core application programming interface (API) and network API.

### Network and User Management Module

The Network and User Management Module is configured to provide administrators with the ability to dynamically create, edit, or deactivate client networks. In some embodiments, the Network and User Management Module is configured to provide an automated sequence of events including creating a client network sub-domain which is exclusively for the specific network, sending automated emails including invitations to install the bot or app, confirmations of activations of accounts and subdomains, notification of suspension of an account.

The Network and User Management Module enables the administrators to create network admin accounts as well as user accounts. The account creation uses several options including but not limited to automatically created accounts through integration with the Network API, importing bulk users through a data file, and manually adding or deleting individual users through the interface.

In some embodiments, the Network and User Management Module is configured to accept feedback from team members regarding other team members and optionally provides team members opt-out options with respect to certain team members.

In some embodiments, the Network and User Management Module is configured to allow the administrator to select a subset of team members to receive a specific question or set of questions.

In some embodiments, the Network and User Management Module is configured to provide options with respect to team member interfaces. In some embodiments, the Network and User Management Module may allow the administrator to set an introduction to the question session that can include details regarding company policies.

In some embodiments, administrative options are presented in a progressive contextual manner rather than using a full menu with more options than the administrators are ready for. Once the administrators are in any part of the administrative flow, the administrators will also be able to focus on only that task. If any subsequent actions are required, the administrators will automatically be taken through the next steps

### Question Engine

The Question Engine is configured to progress team members' engagement with and knowledge of each other from the surface to the core. In some embodiment, the Question Engine uses the Social Penetration Theory. The Question Engine is configured to interact with the Questions Database. The Questions Database includes the set of questions used in the method. In some embodiments, the questions are sourced from Myers Briggs, Big 5 or OCEAN, entrepreneurial trait assessment, gamer profiles, recruiting resources, and career development and relationship-building models. The questions are characterized and tagged in accordance with a four-point scale that aligns with the Social Penetration Theory (1 of 4 is Surface, 2 of 4 is Personal, 3 of 4 is Intimate, and 4 of 4 is Core). The outside or superficial levels or layers include a mix of lower weighted questions (1 of 4 and 2 of 4), the deeper levels or layers move to a mix of progressively higher levels as the team begins to build trust with each other and the platform.

The Question Engine is configured to provide team members first engaging the method a mix of lower weighted questions (1 of 4 and 2 of 4), and move to a mix of progressively higher levels as the team begins to build trust with each other and the platform.

In some embodiments, the Question Engine is configured to provide questions on a schedule and optionally provide a time limit for answering the questions. For example, the Question Engine may be configured to provide a certain number of questions per set time period on a specific schedule. For illustrative purposes, the Question Engine may provide a team with 3 questions per week (for example, on Monday, Wednesday and Friday). Optionally, the questions will be weighted differently. For example, the questions on Monday and Friday could be a mix of lower weighted questions, while Wednesday will be a slightly higher weighted question. E.g.: Monday is a 2 of 4, Wednesday is a 3 or 4 and Friday is a 1 of 4. The Question Engine may further be configured to include a set number of question rounds. In some embodiments, the method and system are configured to include a minimum number of rounds. For example, in one embodiment, the amount of questions per 6-week minimum engagement will be 18 (3 questions×6 weeks of engagement) with a cycle of questions (1-3 STP and complexity) cycling every five days.

In some embodiments, the complexity of the questions is scheduled to encourage effort over outcome. In some teams working on a five day a week schedule, Friday can be a day of happy-hours and wrapping up of the week. Offering a simple question at the end of the week may encourage engagement with the group or team without asking for mass effort from the user so as to not add to the buildup of business at the end of the week.

The Question Engine sets the time period for answering the questions. The time period for answering a specific question may be open-ended, or set for a specific number of minutes, hours or days. In some embodiments, the time period for answering each question is set individually. Alternatively, the time period for answering the question may be based on the day the question is sent. For example, between Monday and Wednesday, and Wednesday and Friday questions, the Question Engine may set the answer period at 48 hours, while between Friday and the following Monday, Question Engine may set the answer period to 72 hours. In some embodiments, team administer sets the timing of questions and answer period. In some embodiments, timing can be adjusted, for example extended, by the team administer to allow for more time to answer or if unanticipated events delay team members participation.

In some embodiments, the Question Engine is configured to provide the next question as soon as the answer to the previous question is submitted.

The Question Engine, in some embodiments, is configured to set the time of the day the questions are sent. In some embodiments, the Question Engine may be configured to send the questions at the same time each day or alternative the Question Engine may be configured to send the questions at a set time individualized for each team member, for example 2 hours before start of day (local time).

The Question Engine is further configured to send the questions out in a particular sequence based optionally on Social Penetration Theory.

The Question Engine is optionally configured to adjust timing and frequency of questions in response to user feedback or in response to response rate data.

The Question Engine may further be configured to provide users with the option to defer (i.e. snooze) a question. In such embodiments, the “snooze” time may be set; optionally a maximum snooze period may be set by the administrator.

The Question Engine may be optionally configured to allow a team member to skip or bypass questions. In some embodiments, if question is skipped or bypassed an alternative question is provided.

### Conversation Engine

The Conversation Engine is operative with the Question Engine and is configured to provide the element of reciprocity which encourages team members to share of themselves in order to learn about others. In particular, the Conversation Engine controls which question answers can be viewed and by whom. In some embodiments, the Conversation Engine is configured to restrict the viewing of answers to only those team members who have also answered the question. For example, if a team member has not answered a question, they cannot view their colleague's answer to that question. In some embodiments, level of sharing is adjustable by the team administrators.

The Conversation Engine is further configured to facilitate person-to-person conversations. In some embodiments, the Conversation Engine groups team members based on which questions they have answered. Each team member can belong to more than one group. In some embodiments, the Conversation Engine is configured to advise team members when other members have answered the same question.

In some embodiments, the Conversation Engine directs team members who have answered a specific question to a group channel where they can engage around each other's' answers. The answers are optionally pinned to the channel so that each time a new team member enters, they can review the answers and quickly begin to engage in the conversation. Once the time period for a question has passed, the channel will be archived and a new channel will begin with the immediate next question. Optionally, archived questions and answers may be viewable. In some embodiments, answers to questions are only temporarily stored.

In some embodiments, team members can engage with each other's answers through open text submission or optionally by grounding their response in Aristotle's Triangle. For example, team members may use a visual representation for each side (Ethos, Pathos and Logos), to mark their perception of the answer.

In some, embodiments, the system and method provide for the tracking and measuring of perceived ethos (credibility), pathos (emotional connection), and logos (logic), each of which can be tracked and measured. Members answer a variety of questions tagged E, P and/or L. The levels of EPL that each member achieves depend on 2 variables: 1. the number of questions the member answers within each category and 2. the rating their answers receive from other members. Optionally, the system and method may be configured to provide users with feedback to gain self-awareness and deeper understanding of the impression they make on others.

In embodiments where an EPL assessment is completed the assessment is based on the volume of tagged questions answered and the community rating of the answers.

### Notification Engine

The system comprises a Notification Engine to handle all notifications whether they are for all users, all users in a specific network, or individual users based on their contextual experience.

Notifications may be broadcast to browsers, operating system notification services, emails, slack direct messages, mobile app notifications or text messages.

The Notification Engine provides messages include but are not limited to system maintenance messages, announcements related to new services and features, information specific to a user's account and related to the question experience, prompts related to introductions and collisions, prompts from other users, etc.

### Reporting Engine

The system comprises a Reporting Engine responsible for processing all of the data being captured and stored by the system for all user actions and optionally presenting them in reports detailing user activity and identifying insights. These reports are available with different levels of detail.

### Core API

The system comprises a Core API which is configured to handle all of the business logic of the behavior of system and makes it available to various clients' interfaces such as the web site, mobile apps, bots, and so forth. It enables a higher level of conformity and consistency of behavior, improved security and access control, and improved scalability. It also enables system to deploy enhancements and new features with greater agility and shortened timeframes.

### Network API

The system comprises a Network API that enables client networks to directly integrate with system. The Network API may allow users' accounts to be created, updated, or deleted; user accounts may include the following basic information, if appropriate, as well as other possible custom fields name, email, photo, job title, department and division. The Network API may also allow information with respect to user information to be deleted from the system after a set period of time.

The Network API may be further configured to generate login “magic links” for network users directly from their network portal or emails sent to them by their network.

### Network Dashboard

In some embodiments, the system includes a Network Dashboard configured to member activity and track or record member insights.

The Network Dashboard may be configured to provide a variety of member activity reports. In some embodiments, the reports are accessible to Network Administrators and provided details regarding who and how many of their members are engaging with the system. The reports may include one or more of the following total teams installed, total user groups invited, total users invited, number of users logged in, number of members that login per day/week/month on average, frequency of logins/sessions for the average member, breakdown of how users are logging in, number of members online now, number of users who have completed on-boarding, total questions answered, number of collisions introduced, member interactions, including member-to-member interactions such as number of marking of EPL on a members question, number of times members submitted feedback on a member response and number of conversations started, members added, members list including not-activated (invited but never logged in), dormant (have not logged in past XX days, active (logged in within past 30 days), number of collisions, number of conversations, and EPL score, last login histogram, member account management log, member question contribution, average time each user spends on system, average number of questions each member answers, indication of top three starred questions, total user comments in discussion channels, number of ignored collisions, number of favorite collisions, number of save for later, starred, back, skip actions aggregate breakdown of questions asked versus percent answered, EPL breakdown of questions asked versus percent answered, number of comments generated per question, number of comments generated per EPL type, number of users engaged in discussion per question, number of users engaged in discussion per EPL type, average time in days : hours : minutes from when a question is asked and the answers are received, number of times commands were used: /later, /time, /policies, /feedback, /explore, /help and breakdown of which categories and questions have the highest level of interest (by % answered)

In some embodiments, individual user reports may be generated and may include total questions answered to date, total user comments in discussion channels to date, questions asked versus percent answered, EPL breakdown of questions asked versus percent answered, number of comments generated per question, number of comments generated per EPL type, average time in days:hours:minutes from when a question is asked and the answers are received, number of times commands were used: /later, /time, /policies, /feedback, /explore, /help, transcript of all discussions filtered by user-author and transcript of all discussions filtered by user-mention.

In some embodiments, the system is configured to provide Member Insights reports that included aggregated reflections of insights gained about the members and their particular behavior and responses. The reports may include an automated analysis summary of the discussions that details aspects of the discussion including sentiment, tine, topic cloud, and EPL analysis, aggregate EPL score of all members, and anonymized percentile breakdowns of members and EPL tiers, change in EPL scores overtime; personality type summaries, and comparison of members to other networks.

### Data Storage Layer

The system comprises various data storage layers including User Database, Question Database and Relation Database.

The User Database (UD) contains all records related to an individual user and with all Personally Identifiable Information (PII) encrypted as a security precaution. In some embodiments, the UD includes all actions performed by users and serves as a key part of the data set that is analyzed by the science engine.

The UD stored data includes but is not limited to answers to questions, postponed questions, invoking privacy/sharing options on particular questions, marking specific questions as being important to them, skipped questions, amount, frequency, and user tagging of discussions between two or more participating users in the discussion channel, comments and reactions (e.g. EPL tagging, adding Slack “reactions”, pinning, etc.) to member answers and comments in the course of the discussion, interactions within or related to the Relational Profile including which individuals are explored by a specific user, which question categories are explored, which common questions are read, which previously unanswered questions are answered in order to reveal more information about the individual, which questions does the individual invite the other person to answer so that they may both learn about each other, actions on specific answers revealed including marking EPL and submitting a comment, pinning and adding additional reactions.

The Question Database (QD) contains a rich structured, categorized, tagged, and emersion based set of questions that are designed in accordance with psychological principles to help foster the key objectives of gaining self-awareness, learning about others, and building trust and digital rapport. The question database is fully manageable and is configured to be enhanced or updated in time to deliver better results and richer engagement experiences. The Question Database may include grouping of related questions into clusters, defining dependencies and parent relationships of questions upon other questions or other clusters, support for both multiple choice questions or open text questions, and other forms of questions, support for both text and media based questions and answers, individual options for each question to define including whether a question may be skipped or marked as private, weighting of display prioritization, tagging of EPL, tagging to map equivalencies to other psychological frameworks (e.g. O-C-E-A-N) to enable further analysis and reporting, tagging of complexity, tagging along scale of social penetration theory to allow journey mapping of questions to the user's length of engagement and complete ability to manage answer options including the values, order, EPL tagging, among other settings. The QD also contains information related to the scheduling of questions based on both globally defined rules for all networks and teams participating with system as well as rules that can be applied for a specific network or team. Each rule, referred to as Question Slot Type (QST), includes details such as unique name, day of week, time of day (in UTC standard), one or more nested definitions that include the following details and help define, in combination with other QST and serves as the scheduling governor of the progression of the question experience.

In some embodiments, the general progression of a given network or team comprises (i) unique and non-overlapping time period for the relative engagement (e.g. week 1 to week 5) so that this rule applies to each participating network or team in accordance with their respective starting date, (ii) scale of Social Penetration Theory that available unanswered questions must match to be eligible for this QST and (iii) scale of Complexity Level that available unanswered questions must match to be eligible for this QST.

The Relational Database (RD) contains all the information necessary to compare one user to another one. It identifies both similarity and difference in order to allow users to explore others in a meaningful way. The RD plays a key role in driving users to reveal more about their selves so that they can learn more about others, prompting others to share their information and feeding the algorithm with the data necessary to measure similarity and difference of one person against others.

### Science Engine

The system utilizes an algorithm for analysis of user behavior and measurement of what users do, what they don't do. In existing teams embodiments, the analysis of both individual user data (e.g. in response to questions) and team interactions (e.g. via the actions and comments in group discussions) takes place in order to measure and track team cohesiveness, as represented by our proprietary mathematical model and as explicitly obtained through a scheduled team feedback question. This is tracked over time and in context to the team's interactions with specific patterns in the question experience. Details like which types (categories, EPL, social penetration theory scale, complexity scale, day, time, frequency) and combinations of questions and associated details are yielding positive trends and which are not as effective are calculated and help the system adjust the experience to ensure the most productive and rewarding outcomes.

For large corporate or professional network embodiments, the analysis of individual user data (e.g. in response to questions and eventually to introductions to other members) takes place in order to measure complementarity of users. All individual user data in addition to the mathematical extraction of traits and behavior of individuals within cohesive and productive teams adds as a further factor in the statistical model. The algorithm is designed to analyze data and context to generate a probability of the strongest complementarity between individuals—both as a measure of the health/strength of the relationship as well as the likelihood of successful new relationships through system brokered introductions.

In embodiments configured to analyze potential additions or changes to existing teams, the science engine can also assess the likelihood of a new potential addition to a team of being able to integrate effectively. Similarly, it can highlight any existing individuals that are lagging in effective integration with the team as well as highlight the primary factors for this. This information can be utilized by system to adapt the engagement with this individual in order to better suit their individual behavior.

Operational aspects of the science engine algorithm may include:
Describe a User's profile by a numeric vector, incorporating the network they belong to, the questions they've answered, and the free text they've entered. The questions answered are described via “one-hot” encoding. The free text is translated to a numeric vector using LDA (latent Dirichlet allocation) built from the corpus of text entered by all users.
Vectors are updated periodically to capture changes in the set of questions, answers, text entered, etc.
The vectors are used to power an API computing user similarity. The top similar users (as defined by the cosine distance from a given user's vectors) are returned from the API on request.
Using a combination of the vectors and historical “successful matches” also called collisions—a machine learning classifier is trained to predict whether or not two users will have a “successful match”. Successful match is defined as: a user A is suggested that they might like to connect with user B, and clicks that they are interested.
The machine learning classifier—having been trained—can be used in place of the similar-users-api to instead return a set of users who are most likely to be successful matches. So rather than compute the most similar users (in terms of their profile), the model will, for a given user, compute the set of users “most likely” to be successful matches and return those.
The model is retrained periodically to capture new responses (both successful and unsuccessful) and improve its scoring mechanism.

### Integration Module

The system in some embodiments includes an integration module to facilitate integration with team collaboration and messaging platforms. The integration module may further provide for integration with other online collaboration tools and existing corporate and professional network.

### Realtime Analytics Module

In some embodiments, the system includes a real-time analytics module configured to analyze system and user data to determine behavior patterns and optionally feed back into its calculations and adaptive model.

In some embodiments, the module enables monitoring the level to which each network or team interacts with system, identifies user engagement levels in relation to question categories, EPL, timings, frequency, social penetration theory, and complexity, monitors how each network and individual members within it are reacting to the various questions and how effective they are in sparking robust discussions, determines which features and commands are members using the most, evaluates feedback from participating members—both unsolicited and in response to scheduled prompts, and/or maps the impact on each team's cohesiveness as a result of their engagement with system

In some embodiments, the analytics module reports aggregated results with the authorized client representative so that they can substantiate their users' usage levels and measured benefits.

To gain a better understanding of the invention described herein, the following examples are set forth. It will be understood that these examples are intended to describe illustrative embodiments of the invention and are not intended to limit the scope of the invention in any way.

### EXAMPLES

### Example 1

Sample User Experience for Slack Teams:

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A computer implemented method for fostering person-to-person engagement in a virtual team having a plurality of team members, the method comprising:
inviting members to a virtual team;
providing a virtual team building environment;
providing each team member of the virtual team one or more questions;
tagging team members based on which of the one or more questions is answered and/or how they answered them;
providing access to all answers to a specific question to those team members who have answered the specific question and
optionally providing an open discussion forum to the team members who have answered the specific question.

2. The computer implemented method of claim 1 , wherein prior to providing each team member one or more questions an opportunity to invite new team members is provided.

3. The computer implemented method of claim 2, wherein the opportunity to invite new team members is restricted to a team administrator.

4. The computer implemented method of claim 2, wherein the invite is provided in an email, text message or instant message.

5. A computer implemented method for fostering person-to-person engagement in a virtual team having a plurality of team members, the method comprising:
providing a virtual team building environment;
providing each team member of the virtual team a first set of questions;
tagging team members based on if one or more questions are answered and/or how they answered them; and
providing access to a second set of questions to those team members which answered at least one question in the first set of questions; wherein each set of questions comprise one or more questions and optionally providing an open discussion forum to the team members who have answered at least one question after each set of questions.

6. The method of claim 5, wherein all answers to the first set of questions is visible to each team member who have answered at least one question in the first set of questions.

7. The method of claim 5, wherein all answers to a specific question in the first set of questions is visible to each team member that answered the specific question in the first set of questions.

8. The method of claim 5, wherein each question of the one or more question is tagged based to correspond to one or more rhetorical appeals.

9. The method of claim 8, wherein the one or more rhetorical appeals is selected from ethos, pathos and logos.

10. The method of claim 5, further comprising
providing each team member who have answered the second set of questions with a third set of questions;
segregating team members based on which of the one or more questions in the third set of questions is answered; and
providing access to a further set of question to those members which answered at least one question in the third set.

11. The method of claim 8, comprising gathering data on answer rate for questions based on rhetorical appeals.

12. The method of claim 11 , further comprising selecting said further question asked based on answer rate.

13. The method of claim 5, wherein said sets progress based on social penetration theory.

14. The method of claim 1, wherein said questions are sourced from Myers Briggs, Big 5, OCEAN or combination thereof.

15. The method of claim 1, further comprising providing a prompt to team members who do not answer the one or more questions within a specified time period.

16. The method of claim 15, wherein providing a prompt comprises notifying a team member who has answered the questions that a specific team member has not answered the questions and requesting permission to send a prompt on the answering team member's behalf.

17. The method of claim 1, wherein each question has a set period in which an answer may be provided.

18. The method of claim 1, wherein an alternative one or more questions is provided to team members who has not answered the one or more questions.

19. A system configured to implement a method for fostering person-to-person engagement in a virtual team having a plurality of team members, the system comprising:
one or more servers configured to host a virtual team building environment; the one or more servers comprising one or more physical processors configured to execute computer program modules, the computer program modules comprising:
a network and user management module configured to provide a user interface;
a user database comprising a plurality of user records;
a question database comprising a plurality of questions, each question has one or more tags;
a question engine configured to provide questions to active users in the user database on set schedule, and
a conversation engine operative with the question engine and user database,
wherein the question engine selects questions from the question database based on the one or more tags and wherein conversation engine is configured to restrict viewing of answers to questions posed only to team members who have also answered the question.
